(19) United States
(12) Patent Application Publication
(10) Pub. No.: US 2013/0227397 A1
(43) Pub. Date: Aug. 29, 2013

(54) FORMING AN INSTRUMENTED TEXT SOURCE DOCUMENT FOR GENERATING A LIVE WEB PAGE

(71) Applicants: Evgeny Tvorun, Woodinville, WA (US); Charles Yvon Bissonnette, Redmond, WA (US)

(72) Inventors: Evgeny Tvorun, Woodinville, WA (US); Charles Yvon Bissonnette, Redmond, WA (US)

(73) Assignee: Microsoft Corporation, Redmond, WA (US)

(21) Appl. No.: 13/404,391

(22) Filed: Feb. 24, 2012

(51) Int. Cl. G06F 17/00

(52) U.S. Cl. 715/235; 715/234

(57) ABSTRACT

A method includes parsing at least one text source document to construct a document node tree such that the document node tree includes location information indicating a location of text within the at least one text source document corresponding to each node of the document node tree, and wherein the document node tree includes source identification information that identifies a source document for at least one node in the document node tree. The source identification information is added to the at least one text source document, thereby forming at least one instrumented text source document. A live web page is generated with a browser based on the at least one instrumented text source document.

### CROSS-REFERENCE TO RELATED APPLICATIONS

This Utility Patent Application is related to U.S. patent application Ser. No. 13/167,229, Attorney Docket No. 331809.01, entitled “LINKING SOURCE CODE TO RUNNING ELEMENT,” filed Jun. 23, 2011, and to U.S. patent application Ser. No. 13/167,325, Attorney Docket No. 331810.01, entitled “DYNAMICALLY UPDATING A RUNNING PAGE,” filed Jun. 23, 2011, which are incorporated herein by reference.

### BACKGROUND

Web development tools enable developers to diagnose HyperText Markup Language (HTML) and Cascading Style Sheets (CSS) problems. Developers can dynamically modify Document Object Model (DOM) elements including CSS selectors and see the changes reflected immediately in the running page in a browser. To permanently apply the modifications to the markup text source document from which the page originates, however, the developer needs to locate and appropriately modify the markup text or originating JavaScript associated with the desired modification. Locating the source code text associated with the desired modification may be difficult, however, since the associated source code text might not be immediately obvious or might originate in code with which a developer is not familiar. In addition, once the source code text associated with the desired modification is located, several steps may be needed to apply the modification and actually see the results of the modification in a browser.

### SUMMARY

One embodiment provides a design tool that uses markup instrumentation and works with live pages as they are loaded in a web browser. By using markup instrumentation, extra data is added to markup entities (e.g., HTML elements' attributes, CSS properties, etc) which does not affect appearance in browsers, but allows design tools to link live entities to the source markup. This allows tools to perform such tasks as selection to source markup synchronization, incremental markup editing with live page update, diagnostics information like markup versus live page differences, etc. One embodiment is directed to a method of applying markup instrumentation to a markup source document, and using the instrumentation on live dynamic pages (e.g., built up through composition of different sources of markup documents and combined at runtime), and linking a given markup entity on the live composite page to the source document where this markup entity comes from.

One embodiment is directed to a method that includes parsing at least one text source document to construct a document node tree such that the document node tree includes location information indicating a location of text within the at least one text source document corresponding to each node of the document node tree, and wherein the document node tree includes source identification information that identifies a source document for at least one node in the document node tree. The source identification information is added to the at least one text source document, thereby forming at least one instrumented text source document. A live web page is generated with a browser based on the at least one instrumented text source document.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated, as they become better understood by reference to the following detailed description. The elements of the drawings are not necessarily to scale relative to each other. Like reference numerals designate corresponding similar parts.

FIG. 1 is a block diagram illustrating a web development tool according to one embodiment.

FIG. 2 is a block diagram illustrating a computing device/environment suitable for implementing aspects of the web development tool illustrated in FIG. 1 according to one embodiment.

FIG. 3 is a functional block diagram illustrating a web development tool according to one embodiment.

FIG. 4 is a block diagram illustrating one example of HTML text mapped to a document node tree.

FIG. 5 is a block diagram illustrating one example of a document node tree mapped to a view node tree.

FIG. 6 is a block diagram illustrating one example of a view node tree for a DOM represented by a browser instance.

FIG. 7 is a block diagram illustrating one example of HTML text and its corresponding document node tree, including instrumentation information, according to one embodiment.

FIG. 8 is a diagram illustrating original markup text and its corresponding instrumented markup text according to one embodiment.

FIG. 9 is a flow diagram illustrating a method for adding markup instrumentation to a text source document and generating a live web page based on the instrumented text source document according to one embodiment.

### DETAILED DESCRIPTION

In the following Detailed Description, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that features of the various exemplary embodiments described herein may be combined with each other, unless specifically noted otherwise.

Available web markup design tools provide tooling by means of parsing and rendering source markup content like HTML, XHTML, CSS, etc. files. A significant limitation of these tools is that design time look and feel of web pages (i.e., design time web page rendering) significantly differs from how those pages look in web browsers (i.e., runtime rendering). One of the primary reasons for that is that web pages include script which alters their appearance based on back end data. Another reason is that, with the emergence of new libraries and frameworks, the web pages are composed of multiple markup source files which further complicate the task of associating live HTML entities with source markup.

A newer approach to designing web content is to load web content into a browser and then use the browser API to perform tooling tasks. A significant roadblock to this approach is that browsers do not provide source markup information for the web object they create, like HTML elements and CSS rules. A user can query a browser for live Document Object Model (DOM) elements (e.g., HTML elements, text nodes, etc.) and CSS rules. However, given a live HTML element (created by a browser), there is no way to find matching markup in the source file (e.g., like file name (or URL) and location in the file).

One embodiment provides a design tool that uses markup instrumentation and works with live pages as they are loaded in a web browser. The design tool according to one embodiment provides the exact look of live web pages, including script generated content. If script generated content is a composition of markup fragments (e.g., like cloning existing content which was loaded from “this” document's markup or from other markup documents), then the designing experience is improved as most of the content is linked to source markup. One embodiment of the design tool supports round tripping of incremental changes. Modifications to source markup are immediately applied to the live web page without reloading it. Changes to live web page are incrementally written back to the source markup.

By using markup instrumentation, extra data is added to markup entities (e.g., HTML elements' attributes, CSS properties, etc) which does not affect appearance in browsers, but allows design tools to link live entities to the source markup. This allows tools to perform such tasks as selection to source markup synchronization, incremental markup editing with live page update, diagnostics information like markup versus live page differences, etc. One embodiment is directed to a method of applying markup instrumentation to a markup source document, and using the instrumentation on live dynamic pages (e.g., built up through composition of different sources of markup documents and combined at runtime), and linking a given markup entity on the live composite page to the source document where this markup entity comes from.

One embodiment uses custom markup entities to instrument the markup. For example, in one embodiment, custom HTML attributes like data-source-id (e.g. <div data-source-id=‘ . . . ’>) are used to perform HTML instrumentation. Similarly, in one embodiment, custom CSS properties like—source-id (e.g. .myClass {color:red; -source-id: . . . }) are used to perform CSS instrumentation. Source IDs are created while parsing source markup. The design tool stores the source IDs and source markup location for later use. Next, the design tool creates instrumented versions of source markup files, and stages a design time environment that includes the instrumented markup files. Then the design tool uses that environment to load markup documents in a browser. When the design tool interacts with a running page (e.g., performs hit testing to detect HTML elements under a mouse cursor, or queries an HTML element for applied CSS rules), the design tool queries HTML elements for data-source-id attribute values and determines source markup locations. Similarly, the design tool queries CSS rules for -source-id properties to determine source markup using source ID and source markup location information which was collected initially.

By linking live markup entities to source markup, the design experience can be significantly improved by: (1) Displaying source markup for live markup objects (e.g., display HTML element location in a source *.html file); (2) making changes to source markup and updating correct live markup object(s) (e.g., changing <div . . . > attribute value or adding/removing its child elements using a markup source file editor (e.g., text editor) and updating live markup object(s)); and (3) making changes to live markup objects and updating source markup (e.g., changing attribute values or adding/removing its child elements and updating source markup).

These features related to markup instrumentation will be described in further detail below, following the description of a web development tool suitable for implementing these and other features.

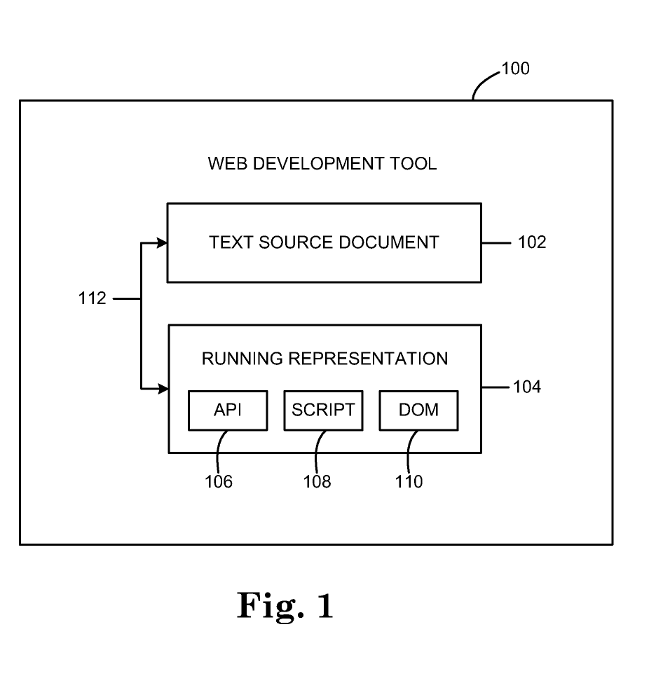

FIG. 1 is a block diagram illustrating one embodiment of a web development tool 100. Web development tool 100 includes a text source document 102 and a running representation 104 of the text source document. In one embodiment, the text source document 102 is opened in a web page source code editor. In other embodiments, text source document 102 or portions of the text source document 102 are displayed in a web page source code viewer. In one embodiment, the running representation 104 of text source document 102 is provided by a browser. In other embodiments, the running representation 104 of text source document 102 is provided by a designer, a property pane, or other suitable visualization of the running representation of the text source document.

A modification to the web page source code is applied to the running page instance of the web page as represented by running representation 104 to dynamically update the running page instance to include the modification to the web page source code. Likewise, a modification to a Document Object Model (DOM) element in the running page instance of the web page is applied to the web page source code to dynamically update the web page source code to include the modification to the DOM element. In this way, a web page developer may modify DOM elements in a running instance of the web page in a browser and/or modify the web page source code and the modifications are dynamically applied to the web page source code and/or the running instance of the web page, respectively.

Web page source code of text source document 102 is linked, via link 112, to associated DOM 110 elements in a running page instance of the web page as represented by running representation 104. Therefore, by selecting or highlighting a DOM element within running representation 104, the web page text associated with the selected or highlighted DOM element is selected or highlighted within text source document 102. Likewise, by selecting or highlighting a portion of the web page text within text source document 102, the DOM element or elements associated with the selected or highlighted portion of the web page text is selected or highlighted within running representation 104. In this way, a web page developer can instantly match DOM elements as they are represented in a running instance of the web page with the web page text source code that defines the DOM elements.

In one embodiment, text source document 102 is opened in a source code editor, which includes any suitable text editor suitable for opening, creating, editing, and saving web page text source documents. In one embodiment, the web page text source documents that can be edited by the source code editor include markup text, such as HyperText Markup Language (HTML), Cascading Style Sheets (CSS), Extensible Markup Language (XML), and/or Extensible HyperText Markup Language (XHTML). The web page text source documents may also include JavaScript or JScript. As used herein, “JS” is used to refer to both JavaScript and JScript. In other embodiments, the source code editor is suitable for opening, creating, editing, and saving web page text source documents including other suitable web page markup text and scripting languages. In one embodiment, the source code editor supports multiple instances of web page text source documents such that related or linked web page text source documents may be simultaneously opened within the source code editor.

In one embodiment, running representation 104 is a web browser suitable for representing a DOM 110. In one embodiment, the browser is a World Wide Web Consortium (W3C) compliant web browser. In one embodiment, the browser provides a browser agnostic representation of a DOM 110 such that the representation of the DOM 110 does not depend on any particular browser, such as Internet Explorer, FireFox, Chrome, Safari, or Opera. In another embodiment, the browser is selected such that the representation of the DOM 110 is based on the selected browser. The browser may include an option for the user to select a particular browser, such as Internet Explorer, FireFox, Chrome, Safari, or Opera, on which to base the representation of the DOM 110. In one embodiment, the browser supports multiple instances of DOMs such that related or linked web pages may be simultaneously running within the browser. Running representation 104 may also include running script 108 and an Application Programming Interface (API) 106. Script 108 and API 106 may modify, delete, and/or insert DOM elements in DOM 110 within running representation 104.

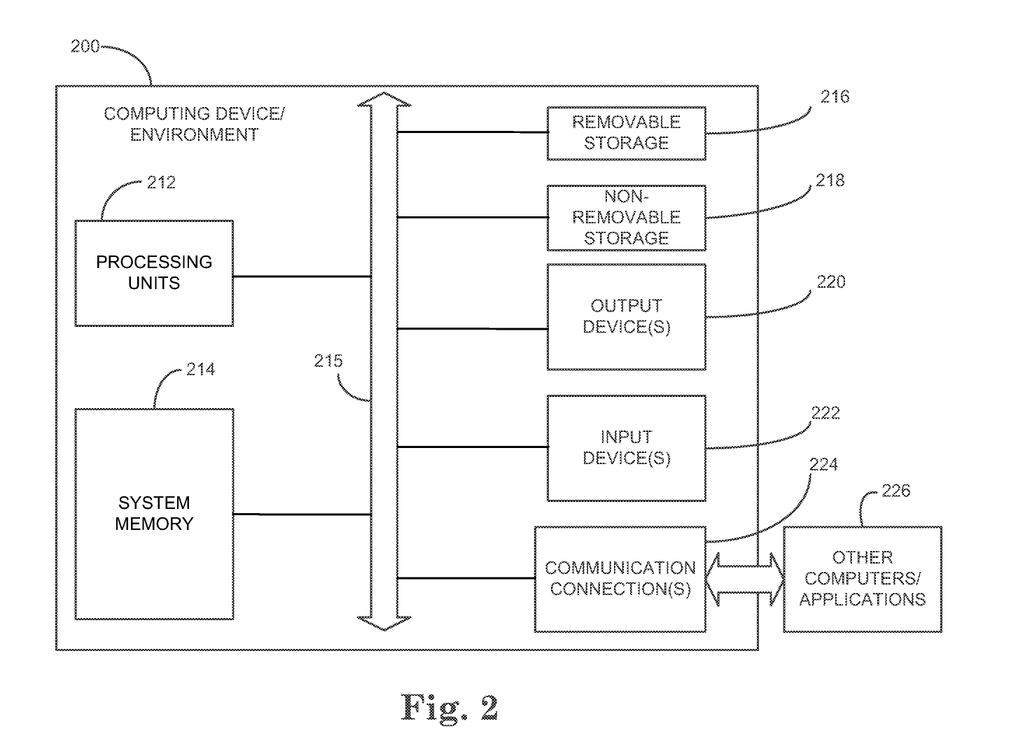

FIG. 2 is a block diagram illustrating one embodiment of a computing device/environment 200 suitable for implementing aspects of web development tool 100 previously described and illustrated with reference to FIG. 1. Computing device/environment 200 includes one or more processing units 212 and system memory 214. Depending on the exact configuration and type of computing device/environment 200, memory 214 may be volatile (such as RAM), non-volatile (such as ROM, flash memory, etc.), or some combination of the two.

Computing device/environment 200 may also have additional or different features/functionality and additional or different hardware and software. For example, computing device/environment 200 may also include additional storage (removable and/or non-removable) including, but not limited to, magnetic or optical disks or tape. Such additional storage is illustrated in FIG. 2 by removable storage 216 and non-removable storage 218. Computer storage media includes volatile and nonvolatile, removable and non-removable media implemented in any suitable method or technology for storage of information such as computer readable instructions, data structures, program modules or other data. Memory 214, removable storage 216, and non-removable storage 218 are all examples of computer storage media (e.g., computer-readable storage media storing computer-executable instructions that when executed by at least one processor cause the at least one processor to perform a method). Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by computing device/environment 200. Any such computer storage media may be part of computing device/environment 200.

The various elements of computing device/environment 200 are communicatively coupled together via one or more communication links 215. Computing device/environment 200 also includes one or more communication connections 224, such as network connections, that allow computing device/environment 200 to communicate with other computers/applications 226. Computing device/environment 200 may also include input device(s) 222, such as a keyboard, a pointing device (e.g., mouse), a pen, a voice input device, a touch input device, etc. Computing device/environment 200 may also include output device(s) 220, such as a display, speakers, a printer, etc.

FIG. 2 and the above discussion are intended to provide a brief general description of a suitable computing environment in which one or more embodiments may be implemented, and is not intended to suggest any limitation as to the scope of use or functionality of the embodiments.

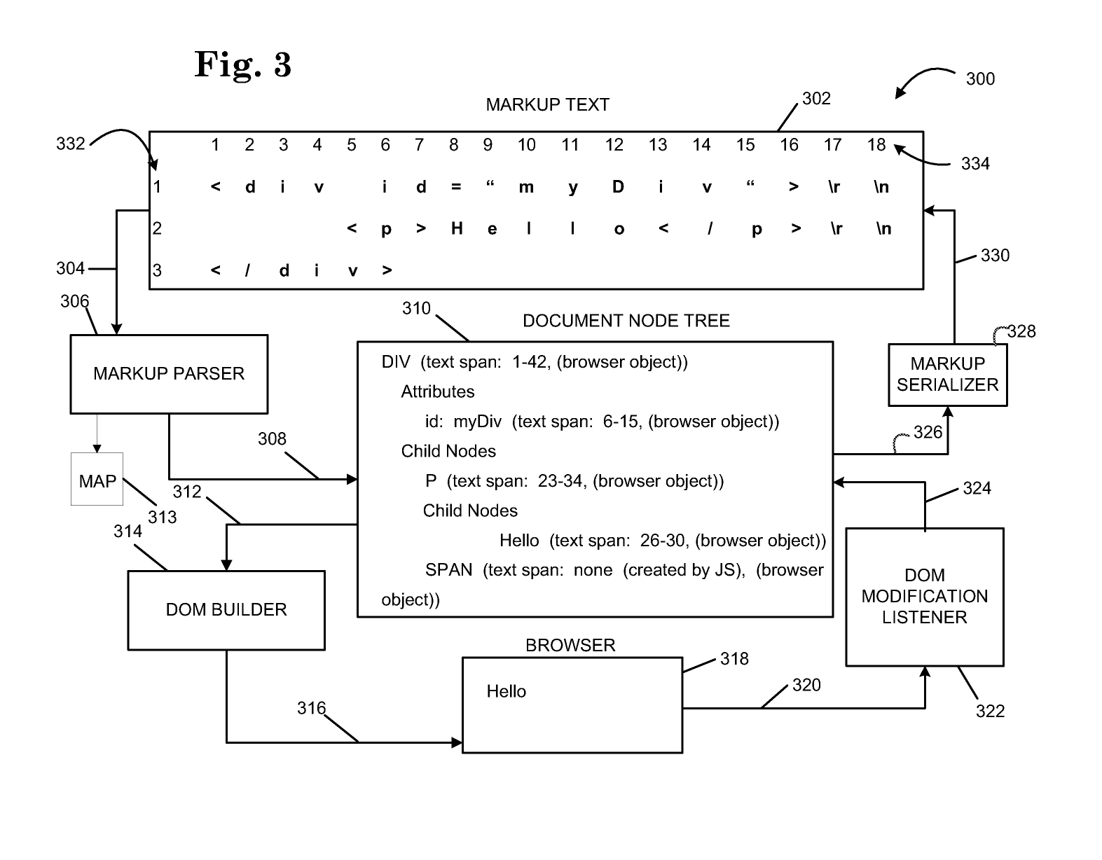

FIG. 3 is a functional block diagram illustrating one embodiment of a web development tool 300. In one embodiment, web development tool 300 provides web development tool 100 previously described and illustrated with reference to FIG. 1. Web development tool 300 includes markup text 302, a markup parser 306, a document node tree 310, a DOM builder 314, a browser 318, a DOM modification listener 322, and a markup serializer 328. Markup text 302 is input to markup parser 306 as indicated at 304. Markup parser 306 outputs document node tree 310 as indicated at 308, and also generates a map 313 for instrumentation information. Document node tree 310 is input to DOM builder 314 as indicated at 312. DOM builder 314 outputs a DOM to browser 318 as indicated at 316. DOM modification listener 322 tracks changes to the DOM elements within browser 318 as indicated at 320. DOM modification listener 322 outputs change information to document node tree 310 as indicated at 324. Markup serializer 328 receives change information from document node tree 310 as indicated at 326. Markup serializer 328 updates markup text 302 with serialized change information as indicated at 330.

Markup text 302 includes HTML, CSS, XML, XHTML, and/or other suitable markup text. In one embodiment, the source document including markup text 302 is opened in a source code editor. In other embodiments, web development tool 300 accesses the source document including markup text 302 without opening the source document in a source code editor. Markup text 302 defines any suitable number of objects for providing a web page. In the example illustrated in FIG. 3, markup text 302 includes HTML. The example HTML defines one object for providing a DOM element including the text “Hello”.

Due to the textual nature of markup text 302, each character of markup text 302 has a corresponding line number as indicated at 332 and a corresponding relative character number for the line as indicated at 334. For example, the character “H” in markup text 302 is at line 2, character 8. Each character of markup text 302 also has a character number that indicates the position of the character relative to the beginning of markup text 302. For example, the character “H” in markup text 302 has the character number of 26 since it is the 26^{th} character in markup text 302. Thus, each character within markup text 302 can be located based on either a line number and position within the line or based on the character number that indicates the position of the character relative to the beginning of markup text 302. Likewise, a series of characters within markup text 302 can be located based on a range of line numbers and positions within the lines or based on a range of character numbers. As used herein, these ranges of line numbers and positions within the lines or ranges of character numbers are referred to as “text offsets.”

Markup text 302 is parsed by markup parser 306 to construct document node tree 310. In one embodiment, markup parser 306 is located on the same computing device/environment as the source code editor. In another embodiment, markup parser 306 is located on a different computing device/environment from the source code editor. Markup parser 306 includes an HTML parser, a CSS parser, an XML parser, an XHTML parser, and/or other suitable markup text parsers. In one embodiment, markup parser 306 is W3C compliant. In another embodiment, markup parser 306 is based on the parser associated with a particular browser, such as Internet Explorer, FireFox, Chrome, Safari, or Opera. In other embodiments, markup parser 306 is a hybrid parser that includes the basic implementation of the parser associated with a particular browser with alterations in the parsing implementation based on knowledge of the particular browser runtime execution and/or parse behavior.

Markup parser 306 includes the source document details from markup text 302, which are relevant to web pages, in document node tree 310. In addition to HTML objects and CSS objects, markup parser 306 includes other details from markup text 302, such as doctype and in-source comments that might be interpreted by browsers. Markup parser 306 also includes text offsets in document node tree 310 indicating the location of the source document details in markup text 302. The text offsets map each node of document node tree 310 to the markup text associated with the node. In this way, a link between document node tree 310 and markup text 302 is maintained during the parsing process. This differentiates markup parser 306 from conventional parsers integrated within browsers, which often discard or transform source document details during rendering for performance reasons and do not maintain any link between the source document and the rendered document.

In the example illustrated in FIG. 3, document node tree 310 uses ranges of character numbers as text offsets. For example, document node tree 310 includes the text offset “text span: 1-42” for the parent node “DIV”, which indicates the location of the object “DIV” in markup text 302. Likewise, document node tree 310 includes the text offset “text span: 6-15” for the attribute “id”, the text offset “text span: 23-34 for the child node “P”, and the text offset “text span: 26-30” for the child node “Hello”. Thus, by including the text offsets for each object within document node tree 310, each object within document node tree 310 is mapped to the source document markup text that is associated with the object.

DOM builder 314 constructs a DOM and a view node tree that represents the DOM from document node tree 310. DOM builder 314 maps each node of the view node tree to a corresponding node of the document node tree such that each element of the DOM is linked to the associated object in document node tree 310 and thereby to the source document markup text that is associated with the object. In one embodiment, DOM builder 314 injects event listeners into the DOM for tracking modifications to the DOM.

In one embodiment, DOM builder 314 constructs JS elements. Once executing, the JS elements may construct and/or modify DOM elements and corresponding nodes within the view node tree, which may not have corresponding nodes within document node tree 310.

In one embodiment, DOM builder 314 constructs a browser agnostic DOM that does not depend on any particular browser, such as Internet Explorer, FireFox, Chrome, Safari, or Opera. In another embodiment, DOM builder 314 is selected such that the DOM is constructed based on a selected browser. DOM builder 314 may include an option for the user to select a particular browser, such as Internet Explorer, FireFox, Chrome, Safari, or Opera, on which to base the construction of the DOM. The constructed DOM is represented by browser 318. In one embodiment, browser 318 is a W3C compliant browser. In the example illustrated in FIG. 3, browser 318 displays a DOM element including the text “Hello” as defined by markup text 302.

The view node tree and document node tree 310 link the DOM elements within browser 318 to markup text 302. For example, by selecting or highlighting “Hello” within browser 318, the associated markup text within markup text 302 is selected or highlighted. Conversely, by selecting or highlighting “<p>Hello</p>” within markup text 302, the associated DOM element “Hello” in browser 318 is selected or highlighted.

DOM modification listener 322 tracks changes to DOM elements, such as DOM mutations, within browser 318. In one embodiment, DOM modification listener 322 tracks changes to DOM elements due to API 106 and/or script 108 (FIG. 1). In one embodiment, DOM modification listener 322 generates a change record for each change to a DOM element. Each change record identifies the modified DOM element by node of the view node tree and the change applied to the node. A change record may also identify a DOM element that has been deleted or inserted. DOM modification listener 322 then updates the corresponding node in document node tree 310 based on the change record.

In one embodiment, changes can be made to DOM elements via document node tree 310 by a user modifying element attributes and/or style properties via a properties panel or other suitable mechanism. In this embodiment, the properties panel generates a change record for each change to an element. Each change record identifies the element to modify by node of the document node tree and the change to apply to the node. The change record updates the node in document node tree 310 based on the change record. DOM builder 314 then updates the DOM and the view node tree that represents the DOM based on the updated document node tree 310 such that the representation of the DOM in browser 318 includes the modification.

Markup serializer 328 serializes change information in document node tree 310 for updating markup text 302. Markup serializer 328 formats the changes to document node tree 310 (e.g., due to change records from DOM modification listener 322 or from the properties panel) to include the information needed to modify markup text 302 to match the updated document node tree 310. In one embodiment, the information provided by markup serializer 328 includes the text offsets indicating the location where the change is to be made in markup text 302 and the new value to place at the indicated location. In one embodiment, markup serializer 328 combines change information for a plurality of changes to document node tree 310 into a single serialized data file to update markup text 302 in a batch process in response to a user action. In another embodiment, markup serializer 328 may update markup text 302 in a batch process including multiple data files.

Changes can also be made to markup text 302 within a source code editor. In one embodiment, after a change to markup text 302, markup parser 306 performs a partial parsing of markup text 302 to update document node tree 310. In another embodiment, after a change to markup text 302, markup parser 306 performs a complete parsing of markup text 302 to update document node tree 310. DOM builder 314 then updates the DOM and the view node tree that represents the DOM such that the change to markup text 302 is reflected in browser 318.

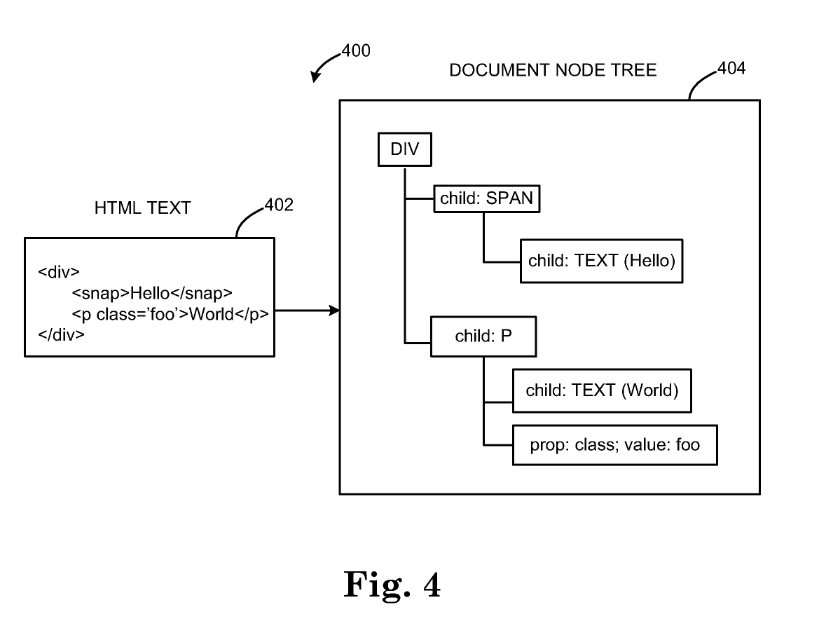

FIG. 4 is a block diagram illustrating one example 400 of HTML text 402 mapped to a document node tree 404. To construct document node tree 404 from HTML text 402, HTML text 402 is parsed by a markup text parser, such a markup parser 306 previously described and illustrated with reference to FIG. 3. In the example illustrated in FIG. 4, HTML text 402 is parsed such that document node tree 404 includes a parent node “DIV” and child nodes “SPAN” and “P”. Child node “SPAN” includes a further child node “TEXT(Hello)”. Child node “P” includes a further child node “TEXT(World)” and a property of “class” with a value of “foo”.

Thus, document node tree 404 maintains the HTML text 402 source document details in a structured tree format. As previously described and illustrated with reference to FIG. 3, document node tree 404 also includes the text offset for each parent and child node to indicate the specific location of the HTML text within HTML text 402 associated with each parent and child node, respectively.

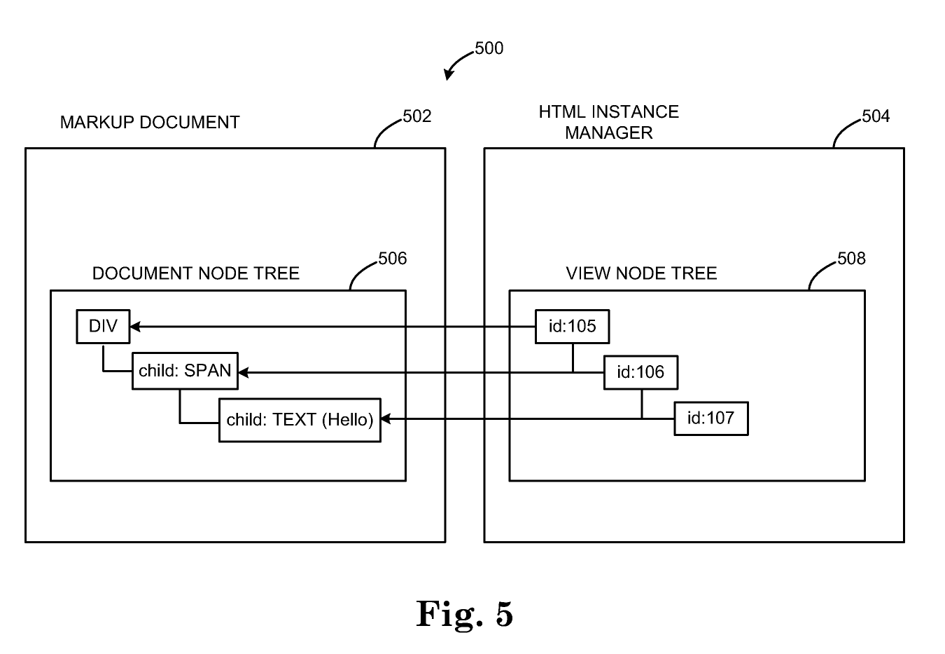

FIG. 5 is a block diagram illustrating one example 500 of a document node tree 506 mapped to a view node tree 508. Document node tree 506 provides the source document details for a markup document 502 in a structured tree format. View node tree 508 represents one instance of a DOM in an HTML instance manager 504. In one embodiment, HTML instance manager 504 can manage multiple instances of view node trees. In one embodiment, view node tree 508, which represents a DOM within HTML instance manager 504 is based on a selected browser. HTML instance manager 504 may include an option for the user to select a particular browser, such as Internet Explorer, FireFox, Chrome, Safari, or Opera, on which to base view node tree 508.

Each node of view node tree 508 includes an identifier that maps each node to an associated node in document node tree 506. In one embodiment, the identifier is assigned to each node of the view node tree by DOM builder 314 previously described and illustrated with reference to FIG. 3. In one embodiment, the identifier is a number. In the example illustrated in FIG. 5, identifier “105” of view node tree 508 is mapped to parent node “DIV” of document node tree 506. Likewise, identifier “106” is mapped to child node “SPAN” and identifier “107” is mapped to child node “TEXT(Hello).” Thus, each identifier of the view node tree links a node of the view node tree to an associated node in the document node tree.

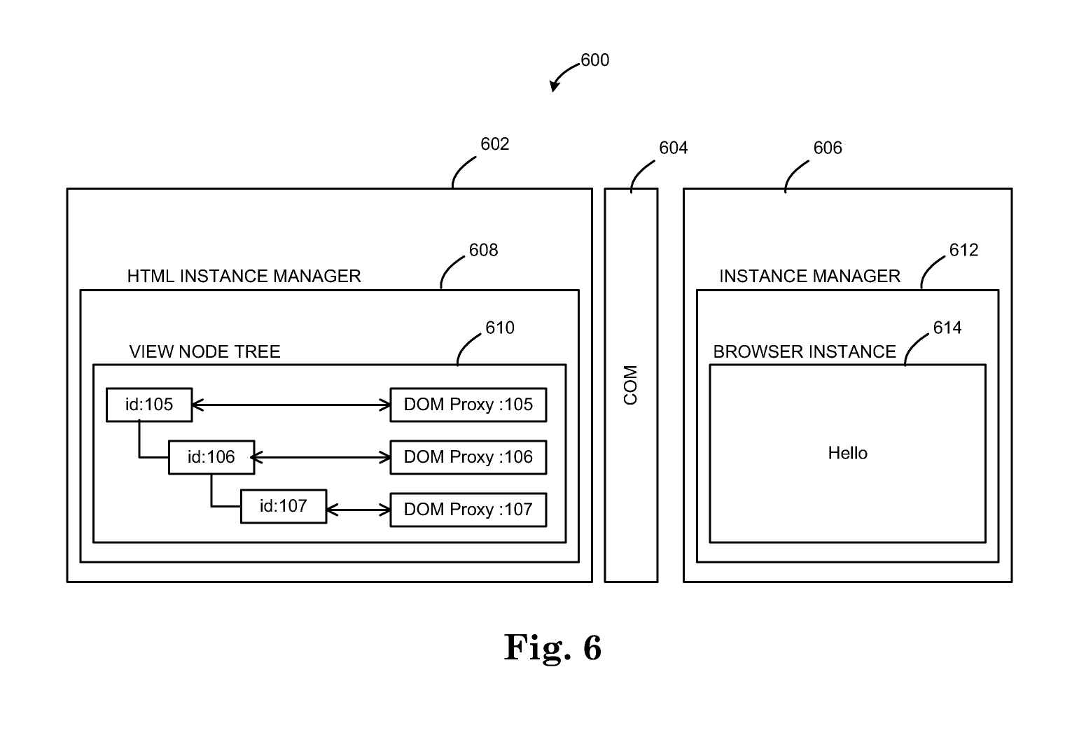

FIG. 6 is a block diagram illustrating one example 600 of a view node tree 610 for a DOM represented by a browser instance 614. An application 602 includes HTML instance manager 608, which manages view node tree 610. In one embodiment, HTML instance manager 608 manages multiple instances of view node trees. An application 606 includes an instance manager 612, which manages browser instance 614. In one embodiment, instance manager 612 manages multiple browser instances. Browser instance 614 represents an instance of a DOM. Application 602 is communicatively coupled to application 606 through a communication link (COM) 604.

The identifier of each node of view node tree 610 is linked to the associated DOM element represented by browser instance 614 as indicated by each “DOM Proxy” in view node tree 610. Thus, each DOM element represented by browser instance 614 is linked or mapped to a node of view node tree 610. Therefore, each DOM element represented in browser instance 614 is linked to the markup text in the markup text source document through the view node tree and the document node tree.

In the example illustrated in FIG. 6, identifier “105” of view node tree 610 is linked to a DOM proxy for identifier “105” of a DOM element represented by browser instance 614. Likewise, identifier “106” is linked to a DOM proxy for identifier “106” and identifier “107” is linked to a DOM proxy for identifier “107”. In this example, view node tree 610 include the identifier “107” linking the child node “TEXT(Hello)” (FIG. 5) to the DOM element “Hello” within browser instance 614.

One embodiment is directed to a method of applying markup instrumentation to a markup source document, and using the instrumentation on live dynamic pages (e.g., built up through composition of different sources of markup documents and combined at runtime), and linking a given markup entity on the live composite page to the source document where this markup entity comes from. In one embodiment, web development tool 300 is configured to perform this method.

The end to end instrumentation process according to one embodiment includes multiple parts: (1) Parsing markup per specifications and version supported by target browser(s) (for example, web development tool 300 will support HTML parsing per HTML5 specifications and CSS parsing per CSS3 specifications if the tool 300 uses Internet Explorer 9 as a target browser); (2) maintaining parser output and additional information, such as the location of parsed nodes in the source markup, and unique instrumentation (string) node ID; (3) serializing parsed markup with the inclusion of the instrumentation information; (4) preparing a design environment for the web browser where it can stage instrumented markup (e.g., it can create a folder and place instrumented markup files in the folder, or it can implement an HTTP server and load the web browser with URLs which make the browser work with the design time HTTP server, and the design tool implementation of the HTTP server can provide the instrumented markup; (5) interacting with web browser to access live web objects, obtain instrumentation information, and use the instrumentation information to link to markup parser output. These parts according to one embodiment are described in further detail below.

Parsing Markup and Maintaining Markup Node Structure

Web development tool 300 parses markup (e.g., markup text 302) to better understand what is being tooled. In one embodiment, markup parser 306 parses markup 302 in the same way as its target web browser. In one embodiment, markup parser 306 is configured to include and maintain additional information, such as source markup location and unique instrumentation ID, in the document node tree 310.

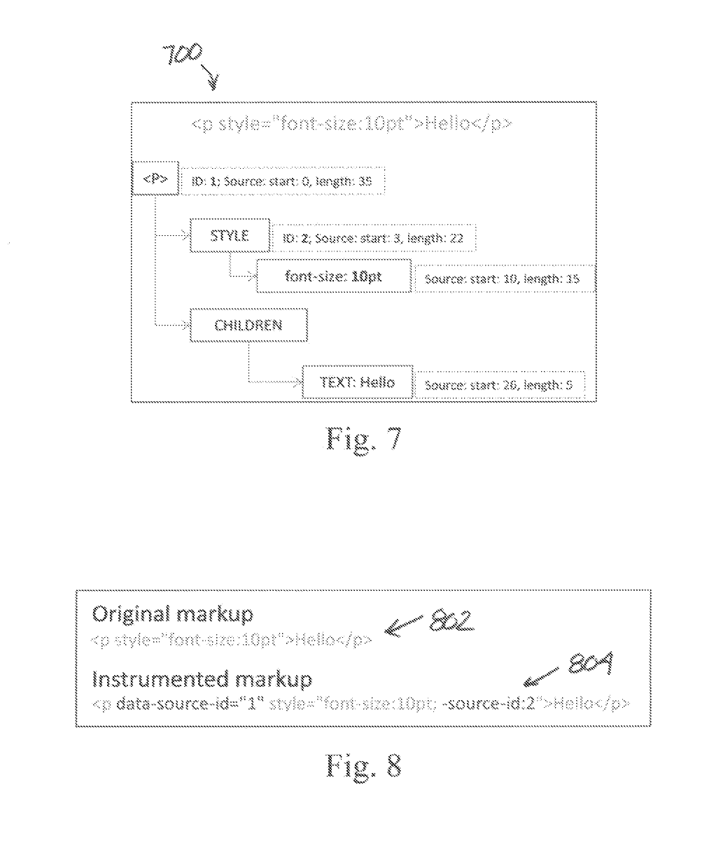

FIG. 7 is a block diagram illustrating one example of HTML text and its corresponding document node tree 700, including instrumentation information, according to one embodiment. As shown in FIG. 7, instrumentation ID, “ID: 1”, has been included for node “<P>”, and instrumentation ID,“ID: 2”, has been included for node “STYLE”.

In addition to storing instrumentation IDs with markup nodes in the document node tree 310, markup parser 306 also creates a map 313 (FIG. 3), which is used to lookup markup nodes by instrumentation ID. Map 313 is used in one embodiment to find markup source for live web objects.

In other embodiments, the actual data model is more sophisticated. There are frameworks that allow composing a web page out of multiple HTML files/pieces. The framework uses script to load additional HTML markup content and then clones that content. For example, a framework can use an HTML fragment as a template of an item in a list view. It will clone that fragment and update some parts of it with data (i.e., bind data to a list view item). For embodiments of web development tool 300 that support editing fragments loaded from different markup (e.g., HTML) files, a more complex instrumentation ID that identifies markup file and then markup nodes within the file is used. Thus, instrumentation ID to markup node mapping in these embodiments include both source markup file and then node within the file.

Serializing Parsed Markup with Inclusion of Instrumentation Information

Once a markup node structure (e.g., document node tree 700) has been created, web development tool 300 can create instrumented markup by adding instrumentation IDs to markup text 302. HTML elements can be instrumented by adding custom attributes (e.g., data-source-id). Similarly, CSS elements can be instrumented by adding custom CSS properties (e.g., -source-id). FIG. 8 is a diagram illustrating original markup text 802 and its corresponding instrumented markup text 804 according to one embodiment. Not all markup constructs can be instrumented in such a way that it will not affect how web pages looks in the web browser. However, each and every node does not have to be instrumented. For text nodes, web development tool 300 can use parent node and/or previous or next sibling elements for instrumentation ID.

Preparing Design Environment for Browser

To use markup instrumentation in a browser, web development tool 300 stages a design time browser environment. All design tools have a concept of a project and/or solution which describes a set of resources (e.g., HTML, CSS and other markup files, images, etc.) which make up a web site or a web application. This information can help design tools determine what markup content (files) are to be instrumented. In one embodiment, the design environment is prepared by creating a new file system folder. Web development tool 300 then parses all of the input markup files and creates corresponding instrumented copies in the newly created folder. In another embodiment, web development tool 300 implements an HTTP server which it uses to make web browser call the HTTP server for all the project data. Web development tool 300 then instruments markup content on demand as it receives requests. In yet another embodiment, web development tool 300 injects certain event listeners and java script to intercept requests for markup content and then again instruments that content on demand.

Interacting with Web Browser to Access Live Web Objects

Once a web browser (e.g., browser 318) has navigated to an instrumented web page, web development tool 300 starts interacting with the page. The tool 300 can hit test the web browser 318 (i.e., query browser 318 for HTML elements under a mouse cursor). Once an HTML element has been identified, web development tool 300 can query it for special instrumentation attributes. In the example shown in FIGS. 7 and 8, a user can click on the “P” element and web development tool 300 will query that element for a data-source-id attribute. Alternatively, web development tool 300 can query the “P” element for applied CSS rules, and then query each of the rules for a -source-id CSS property. Once web development tool 300 determines the instrumentation ID, the tool 300 can then use the map 313 to lookup the markup source. These features provide the ability to perform a number of tooling actions, such as the following.

First, the selection can be synchronized with the markup source. When a user clicks on a particular HTML element in the browser 318, the web development tool 300 can open a text editor (e.g., side by side with the web browser) and select source markup. Moreover, if a web page is composed of multiple markup files, then the web development tool 300 can open the right file and synchronize live selection to markup. As a user selects different entities in the browser 318, the web development tool 300 can open multiple text editors and activate the one matching the current selection in browser 318. This makes for a time saving experience of diagnosing what is coming from where. For example, if a user makes a mistake and uses the wrong markup as an item template for a list view, then selecting an item in a list view can point to the item template source, thereby revealing what is currently being used.

Second, markup changes can be synchronized with live browser objects. Once a user can see source markup for a live web object, the user can now make changes to the source markup (e.g., change HTML element class name in a text editor). Using the identified location in the source markup text, the web development tool 300 can find the corresponding node in the instrumented document node tree 700 and retrieve the node's instrumentation ID. The tool 300 can then find HTML element(s) with that ID in live DOM tree (e.g., using document.querySelectorAll(“[data-source-id=1]”), and update the class name of those elements. This is an improvement over current tools in which a user makes markup changes and then completely reloads a web page, thereby potentially losing current state.

Third, live element changes can be synchronized with markup. When a user selects an HTML element in web browser 318 and the web development tool 300 finds the corresponding source markup and corresponding node in the instrumented document node tree 700, the tool 300 can then compare live attribute values with the markup ones, and identify the differences. The tool 300 can also provide an option of updating markup using live values.

None of the tooling actions described above are provided by current web design tools (as they do not work with “live” web pages) or in the browser debugging experience (as browsers provide only in-browser edits which are not written back to the source markup document).

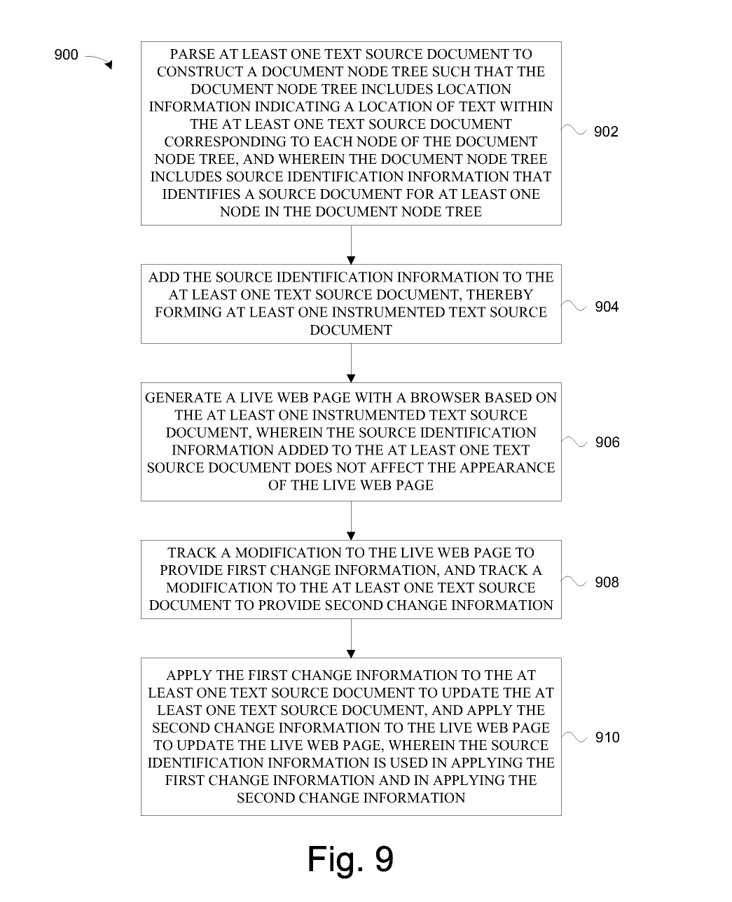

FIG. 9 is a flow diagram illustrating a method 900 for adding markup instrumentation to a text source document and generating a live web page based on the instrumented text source document according to one embodiment. In one embodiment, web development tool 300 is configured to perform method 900. At 902 in method 900, at least one text source document is parsed to construct a document node tree such that the document node tree includes location information indicating a location of text within the at least one text source document corresponding to each node of the document node tree, and wherein the document node tree includes source identification information that identifies a source document for at least one node in the document node tree. At 904, the source identification information is added to the at least one text source document, thereby forming at least one instrumented text source document. At 906, a live web page is generated with a browser based on the at least one instrumented text source document, wherein the source identification information added to the at least one text source document does not affect the appearance of the live web page. At 908, a modification to the live web page is tracked to provide first change information, and a modification to the at least one text source document is tracked to provide second change information. At 910, the first change information is applied to the at least one text source document to update the at least one text source document, and the second change information is applied to the live web page to update the live web page, wherein the source identification information is used in applying the first change information and in applying the second change information.

In one embodiment of method 900, the parsing (902), adding (904), and generating (906) are performed by at least one processor. In one embodiment, the source identification information in method 900 comprises a custom HTML attribute, such as a data-source-id custom HTML attribute. In another embodiment, the source identification information in method 900 comprises a custom Cascading Style Sheet (CSS) property, such as a source-id custom CSS property.

One embodiment of method 900 further comprises: receiving user selection information that identifies an element in the live web page; querying the identified element for a source ID; identifying a text source document that is the source of the identified element based on a result of the querying; and displaying source markup information from the identified text source document corresponding to the identified element in the live web page.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method comprising:
parsing at least one text source document to construct a document node tree such that the document node tree includes location information indicating a location of text within the at least one text source document corresponding to each node of the document node tree, and wherein the document node tree includes source identification information that identifies a source document for at least one node in the document node tree;
adding the source identification information to the at least one text source document, thereby forming at least one instrumented text source document; and
generating a live web page with a browser based on the at least one instrumented text source document.

2. The method of claim 1, wherein the parsing, adding, and generating are performed by a web development tool.

3. The method of claim 1, wherein the parsing, adding, and generating are performed by at least one processor.

4. The method of claim 1, and further comprising:
one of tracking a modification to the live web page to provide first change information and tracking a modification to the at least one text source document to provide second change information.

5. The method of claim 4, and further comprising:
one of applying the first change information to the at least one text source document to update the at least one text source document and applying the second change information to the live web page to update the live web page.

6. The method of claim 5, wherein the source identification information is used in applying the first change information and in applying the second change information.

7. The method of claim 1, wherein the source identification information added to the at least one text source document does not affect the appearance of the live web page.

8. The method of claim 1, wherein the source identification information comprises a custom HTML attribute.

9. The method of claim 8, wherein the custom HTML attribute is a data-source-id.

10. The method of claim 1, wherein the source identification information comprises a custom Cascading Style Sheet (CSS) property.

11. The method of claim 1, wherein the custom CSS property is a -source-id.

12. The method of claim 1, and further comprising:
receiving user selection information that identifies an element in the live web page; and
querying the identified element for a source ID.

13. The method of claim 12, and further comprising:
identifying a text source document that is the source of the identified element based on a result of the querying.

14. The method of claim 13, and further comprising:
displaying source markup information from the identified text source document corresponding to the identified element in the live web page.

15. A computer-readable storage medium storing computer-executable instructions that when executed by at least one processor cause the at least one processor to perform a method within a computing system, the method comprising:
parsing at least one text source document to construct a document node tree such that the document node tree includes location information indicating a location of text within the at least one text source document corresponding to each node of the document node tree, and wherein the document node tree includes source identification information that identifies a source document for at least one node in the document node tree;
adding the source identification information to the at least one text source document, thereby forming at least one instrumented text source document; and
generating a live web page with a browser based on the at least one instrumented text source document, wherein the source identification information added to the at least one text source document does not affect the appearance of the live web page.

16. The computer-readable storage medium of claim 15, wherein the method further comprises:
one of tracking a modification to the live web page to provide first change information and tracking a modification to the at least one text source document to provide second change information; and
one of applying the first change information to the at least one text source document to update the at least one text source document and applying the second change information to the live web page to update the live web page.

17. The computer-readable storage medium of claim 16, wherein the source identification information is used in applying the first change information and in applying the second change information.

18. The computer-readable storage medium of claim 15, wherein the source identification information comprises a data-source-id custom HTML attribute.

19. The computer-readable storage medium of claim 15, wherein the source identification information comprises a -source-id custom Cascading Style Sheet (CSS) property.

20. A method comprising:
parsing at least one text source document to construct a document node tree such that the document node tree includes location information indicating a location of text within the at least one text source document corresponding to each node of the document node tree, and wherein the document node tree includes source identification information that identifies a source document for at least one node in the document node tree;
adding the source identification information to the at least one text source document, thereby forming at least one instrumented text source document; and
generating a live web page with a browser based on the at least one instrumented text source document, wherein the source identification information added to the at least one text source document does not affect the appearance of the live web page;
one of tracking a modification to the live web page to provide first change information and tracking a modification to the at least one text source document to provide second change information;
one of applying the first change information to the at least one text source document to update the at least one text source document and applying the second change information to the live web page to update the live web page; and
wherein the source identification information is used in applying the first change information and in applying the second change information.
